(19) United States
(12) Patent Application Publication
(10) Pub. No.: US 2017/0110235 A1
(43) Pub. Date: Apr. 20, 2017

(54) COIL AND METHOD FOR MANUFACTURING SAME

(71) Applicant: NIPPON CHEMI-CON CORPORATION, Tokyo (JP)

(72) Inventors: Toshikiyo Yoshioka, Tokyo (JP); Katunori Nogami, Tokyo (JP); Hiroshi Ioka, Tokyo (JP); Makoto Ohta, Tokyo (JP); Nobuyuki Yamasaki, Tokyo (JP); Kouichi Nakata, Tokyo (JP); Yuzuru Urabe, Tokyo (JP); Takashi Matsuoka, Tokyo (JP)

(73) Assignee: NIPPON CHEMI-CON CORPORATION, Tokyo (JP)

(21) Appl. No.: 15/389,789

(22) Filed: Dec. 23, 2016

Related U.S. Application Data
(63) Continuation of application No. PCT/JP2015/003448, filed on Jul. 8, 2015.

(30) Foreign Application Priority Data
Jul. 11, 2014 (JP) 2014-143574

(51) Int. Cl. H01F 27/28; H01F 41/04; H01F 27/25; H01F 17/04; H01F 27/02

(52) U.S. Cl. CPC H01F 27/28; H01F 17/04; H01F 27/02; H01F 27/25; H01F 41/04

(57) ABSTRACT

A coil includes a plurality of coil conductor pieces, first and second cores and a case. The plurality of coil conductor pieces is made of a high magnetic permeability material. The first and second cores include through-holes in parallel. The through-holes allow penetration of the coil conductor pieces. The first core and the second core are stored in the case. At least one end part of one of the coil conductor pieces penetrating through the through-holes of the first core and the second core is coupled to an end part of the other coil conductor piece on the outside of the case. A coil conductor circling between the first and second cores is made up of the plurality of coil conductor pieces.

### CROSS-REFERENCE TO RELATED APPLICATIONS

This application is a continuation of International Application No. PCT/JP2015/003448, filed on Jul. 8, 2015, which is entitled to the benefit of priority of Japanese Patent Application No. 2014-143574, filed on Jul. 11, 2014, the contents of which are hereby incorporated by reference.

### BACKGROUND OF THE INVENTION

i) Field of the Invention

The present invention relates to a coil and a method for manufacturing the same.

ii) Description of the Related Art

With regard to a coil, a toroidal coil including a toroidal core is known. This toroidal coil is formed by winding a copper wire around a toroidal core acquired by coating and sintering of iron powder formed into a toroidal shape.

With regard to the toroidal coil, it is known that a plurality of coil pieces is bonded to form a coil (e.g., Japanese Laid-Open Patent Publication No. 63-318114). It is known that an insulating case is put on the toroidal core in such a coil (e.g., Japanese Laid-Open Patent Publication No. 1-152606).

With regard to a method for manufacturing a coil, it is known that a toroidal core is disposed on a die to dispose and wind a copper wire around the toroidal core by using the die (e.g., Japanese Laid-Open Patent Publication No. 2-126615). With regard to a lead wire process of a coil, it is known that a toroidal core is interposed between rails to allow the rails to guide the start and end of winding of a winding wire so as to shape the coil (e.g., Japanese Laid-Open Patent Publication No. 4-3405).

### BRIEF SUMMARY OF THE INVENTION

Since an inductance of a coil is proportional to the number of turns of a winding wire, the number of turns of a winding wire may be increased to make the inductance higher. However, if the number of turns of a winding wire is increased, the winding wire length becomes longer and the direct current resistance of the coil increases in proportion to the winding wire length. When a current flows through the winding wire, the Joule heat is generated in the coil in proportion to the direct current resistance and, therefore, the increased direct current resistance makes the heat generation higher.

In view of the problem, it is an object of the present invention to use, for example, a high magnetic permeability material such as an amorphous material for a core so as to achieve a shortened circling length of a coil conductor and a lower resistance as well as a higher inductance.

An aspect of a coil of the present invention may include a plurality of coil conductor pieces made of a high magnetic permeability material; first and second cores including through-holes in parallel, the through-holes allowing penetration of the coil conductor pieces; and a case in which the first core and the second core are stored, wherein a coil conductor is made up of the plurality of coil conductor pieces, the coil conductor circling between the first and second cores, at least one end part of one of the coil conductor pieces being coupled to an end part of the other coil conductor piece on the outside of the case, the one of the coil conductor pieces penetrating through the through-holes of the first core and the second core.

An aspect of a method for manufacturing a coil of the present invention may include forming coil conductor pieces and forming first and second cores including through-holes allowing penetration of the coil conductor pieces; storing the first core and the second core in a case to arrange the through-holes in parallel; and coupling at least one end part of one of the coil conductor pieces to an end part of the other coil conductor piece penetrating through the through-holes of the first core and the second core to form a coil conductor made up of the plurality of coil conductor pieces, the coil conductor circling between the first and second cores.

Other objects, characteristics, and advantages of the present invention will become more apparent with reference to the drawings and embodiments.

### BRIEF DESCRIPTION OF THE SEVERAL VIEWS OF THE DRAWING

FIG. 1 is a longitudinal sectional view of a coil according to an embodiment.

FIG. 2 is an exploded perspective view of a coil.

FIG. 3 is a view of manufacturing steps of the coil.

FIG. 4 is a view of manufacturing steps of the coil.

FIG. 5 is a view of a first modification example of the coil.

FIG. 6 is a view of a second modification example of the coil.

FIG. 7 is a view of a modification example of a conductor through-hole.

FIG. 8 is a graph of an experimental result.

### DETAILED DESCRIPTION OF THE INVENTION

### Embodiment

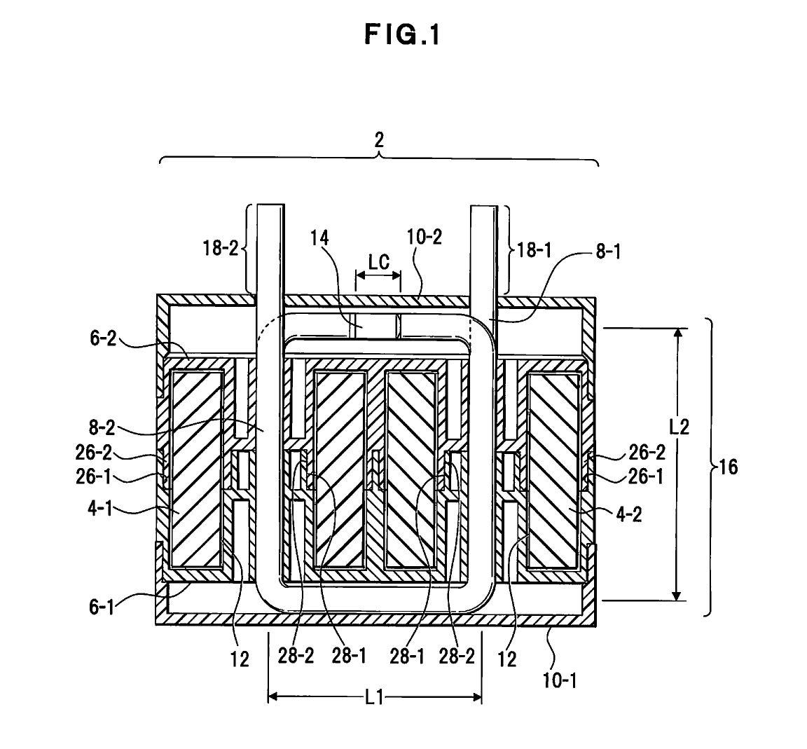

FIG. 1 shows a longitudinal section of a coil according to an embodiment. The configuration shown in FIG. 1 is an example and the coil of the present invention is not limited to this configuration.

A coil 2 includes first and second cores 4-1, 4-2, core cases 6-1, 6-2, coil conductor pieces 8-1, 8-2, and covers 10-1, 10-2.

The cores 4-1, 4-2 are cylindrical bodies of the same shape made of a high magnetic permeability material, for example, and include through-holes 12 arranged in parallel. The cores 4-1, 4-2 are stored in the core cases 6-1, 6-2 and are arranged and positioned in parallel by the through-holes 12.

The core cases 6-1, 6-2 are an example of an insulating mechanism insulating the coil conductor pieces 8-1, 8-2 as well as an example of a storage case in which the cores 4-1, 4-2 are stored, and are made of an insulating synthetic resin, for example.

The coil conductor pieces 8-1, 8-2 are an example of a shaped coil conductor and are made up of conductor materials, for example, copper wire rods. In this embodiment, the coil conductor pieces 8-1, 8-2 are connected by coupling parts 14 to forma circling part 16 disposed in a circling state to the cores 4-1, 4-2. As a result, a coil conductor including a connecting part in a portion is formed.

The covers 10-1, 10-2 are an example of an insulating mechanism insulating the coil conductor pieces 8-1, 8-2 as well as an example of a covering member coupled to the core cases 6-1, 6-2, and are made of an insulating synthetic resin, for example. The covers 10-1, 10-2 cover the coil conductor pieces 8-1, 8-2 exposed from the core cases 6-1, 6-2, and lead parts 18-1, 18-2 are led out on the end part side of the coil conductor pieces 8-1, 8-2.

In this coil 2, when the circling part 16 of the coil conductor pieces 8-1, 8-2 has a length L1 in the horizontal direction of FIG. 1 and a length L2 in the height direction thereof, a length Lm of the circling part 16 is

Lm=L1×3+L2×4 (1),

while a length Ln of one turn of the circling part 16 is

Ln=L1×2+L2×2 (2),

and therefore, the number N of turns of the circling part 16 is acquired by dividing the length Lm of the circling part 16 by the length Ln of one turn as follows:

$$\begin{matrix}N = Lm \text{/} Ln \\ = ( L 1 \times 3 + L 2 \times 4 ) \text{/} ( L 1 \times 2 + L 2 \times 2 ) \\ = 1 + ( L 1 + L 2 \times 2 ) \text{/} ( L 1 \times 2 + L 2 \times 2 ) \\ = 2 - L 1 \text{/} ( L 1 \times 2 + L 2 \times 2 ) < 2.\end{matrix} \qquad ( 3 )$$

Thus, assuming that (L1×2+L2×2)=1 is satisfied, the number N of turns of the circling part 16 is

N=2−L1<2 (4),

which means that the number N of turns of the circling part 16 is the circling number acquired by subtracting L1 from two and is less than two.

When the width of the coupling parts 14 is Lc, the horizontal end parts of the coil conductor pieces 8-1, 8-2 are overlapped and connected in the width Lc.

<Constituent Members of Coil 2>

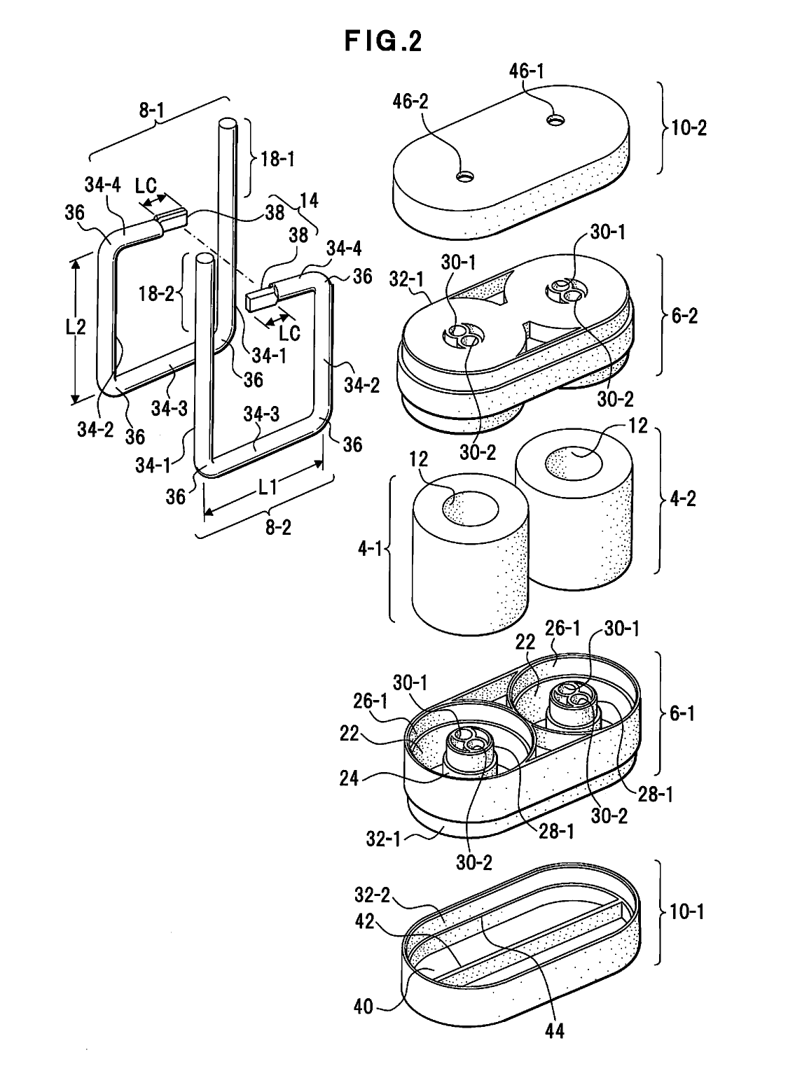

FIG. 2 shows constituent members of the coil 2 in an exploded view. The cores 4-1, 4-2 have the same shape byway of example and are hollow cylindrical bodies having the through-holes 12 formed therein. The cores 4-1, 4-2 are magnetic cores formed by winding and sintering of highly magnetic materials, for example, magnetic alloy (amorphous) ribbons.

The core case 6-1 has a pair of core storage parts 22 each formed into a cylindrical shape with a columnar core supporting part 24 extending vertically at a center part of each of the core storage parts 22. The core storage parts 22 are examples of recesses in which the cores 4-1, 4-2 are stored. The core supporting parts 24 are inserted into the through-holes 12 of the cores 4-1, 4-2. As a result, the lower sides of the cores 4-1, 4-2 are covered by the core case 6-1 and positioned at certain positions.

Large diameter fitting parts 26-1 are formed in opening parts of the core storage parts 22, and small diameter fitting parts 28-1 are formed on the upper sides of the core supporting parts 24. Small diameter fitting parts 26-2 (FIG. 1) are formed in the core storage parts 22 on the core case 6-2 side and inserted into the large diameter fitting parts 26-1. The small diameter fitting parts 28-1 are inserted into large diameter fitting parts 28-2 (FIG. 1) formed in the core supporting parts 24 on the core case 6-2 side. As a result of the fitting at two positions of each of the core storage parts 22, i.e., the fitting at a total of four positions, the core cases 6-1, 6-2 are fitted and coupled to each other.

A pair of conductor through-holes 30-1, 30-2 penetrating the core cases 6-1, 6-2 is formed in each of the core supporting parts 24 of each of the core cases 6-1, 6-2. Separating members of the core cases 6-1, 6-2 are provided between the coil conductor pieces 8-1, 8-2 in the conductor through-holes 30-1, 30-2 allowing penetration of the coil conductor pieces 8-1, 8-2, and the separating members are an example of a wall part interposed between the coil conductor pieces 8-1, 8-2. In this embodiment, the coil conductor piece 8-1 is mounted through the conductor through-hole 30-1, and the coil conductor piece 8-2 is mounted through the conductor through-hole 30-2

Cover mounting part 32-1 is formed on each of the core cases 6-1, 6-2. Each cover mounting part 32-1 is small fitting diameter part, and the cover 10-1 or the cover 10-2 is put thereon.

Conductive wires with circular cross sections are used as an example of the coil conductor pieces 8-1, 8-2. The coil conductor pieces 8-1, 8-2 each include penetrating parts 34-1, 34-2, bridging parts 34-3, 34-4, and bent parts 36. The penetrating parts 34-1, 34-2 are an example of shaft parts of the coil conductor pieces 8-1, 8-2 and are bent at right angles from the bridging parts 34-3 at the bent parts 36 and shaped in parallel with each other. The penetrating parts 34-1 penetrate through the conductor through-holes 30-1 or the conductor through-holes 30-2 of the core cases 6-1, 6-2 and are maintained in parallel with an insulating interval in the core supporting parts 24. The bridging parts 34-3 of the coil conductor pieces 8-1, 8-2 are maintained in parallel on the bottom side of the core case 6-1. The bridging parts 34-4 are inserted into the core supporting parts 24 of the core cases 6-1, 6-2 and then bent in the opposing directions at right angles from the penetrating parts 34-2 at the bent parts 36. A length L3 of each of the bridging parts 34-4 is obtained from the length of each of the bridging parts 34-3, i.e., the length L1, and the width Lc of the coupling parts 14 as follows:

L3=(L1+Lc)/2 (5).

Flat parts 38 are formed at and parts of the bridging parts 34-4 facing each other. The flat parts 38 are overlapped and connected by ultrasonic welding etc. so as to form the coupling parts 14 described above.

The lead parts 18-1, 18-2 are formed of conductor end parts on the extensions of the penetrating parts 34-1.

The cover 10-1 has a conductor storage part 40 formed to store the coil conductor pieces 8-1, 8-2 exposed from the core case 6-1. In the conductor storage part 40, a partition wall 42 is vertically extended and inserted between the coil conductor pieces 8-1, 8-2. The cover 10-1 has an opening part provided with a level difference 44 relative to the conductor storage part 40 to form a case mounting part 32-2. The case mounting part 32-2 is a large fitting diameter part put on the cover mounting part 32-1.

The cover 10-2 has the case mounting part 32-2 and the conductor storage part 40 not shown formed as is the case with the cover 10-1. Since the coupling parts 14 connecting the bridging parts 34-4 of the coil conductor pieces 8-1, 8-2 are disposed in the conductor storage part 40 of the cover 10-2, the partition wall 42 described above is not formed. A pair of leading-out holes 46-1, 46-2 is formed in the cover 10-2. The lead part 18-1 of the coil conductor piece 8-1 projected from the core case 6-2 penetrates through the leading-out hole 46-1 and is led out from the leading-out hole 46-1, and the lead part 18-2 of the coil conductor piece 8-2 projected from the core case 6-2 penetrates through the leading-out hole 46-2 and is led out from the leading-out hole 46-2.

<Method for Manufacturing Coil 2>

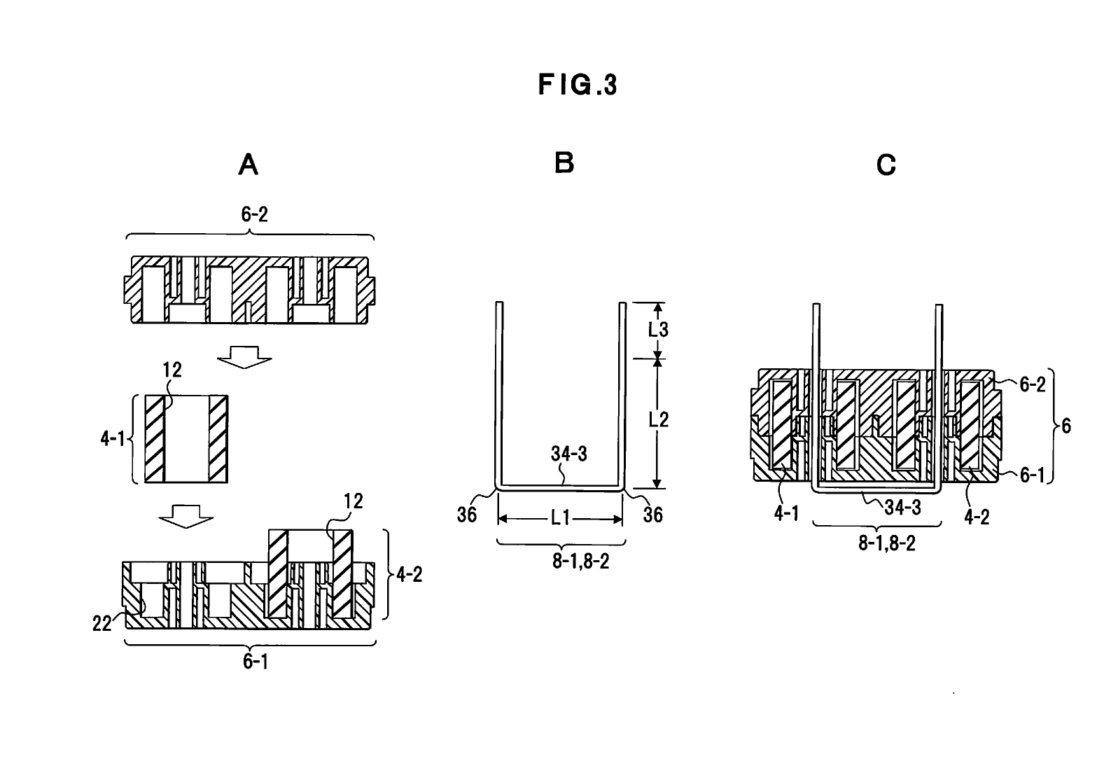

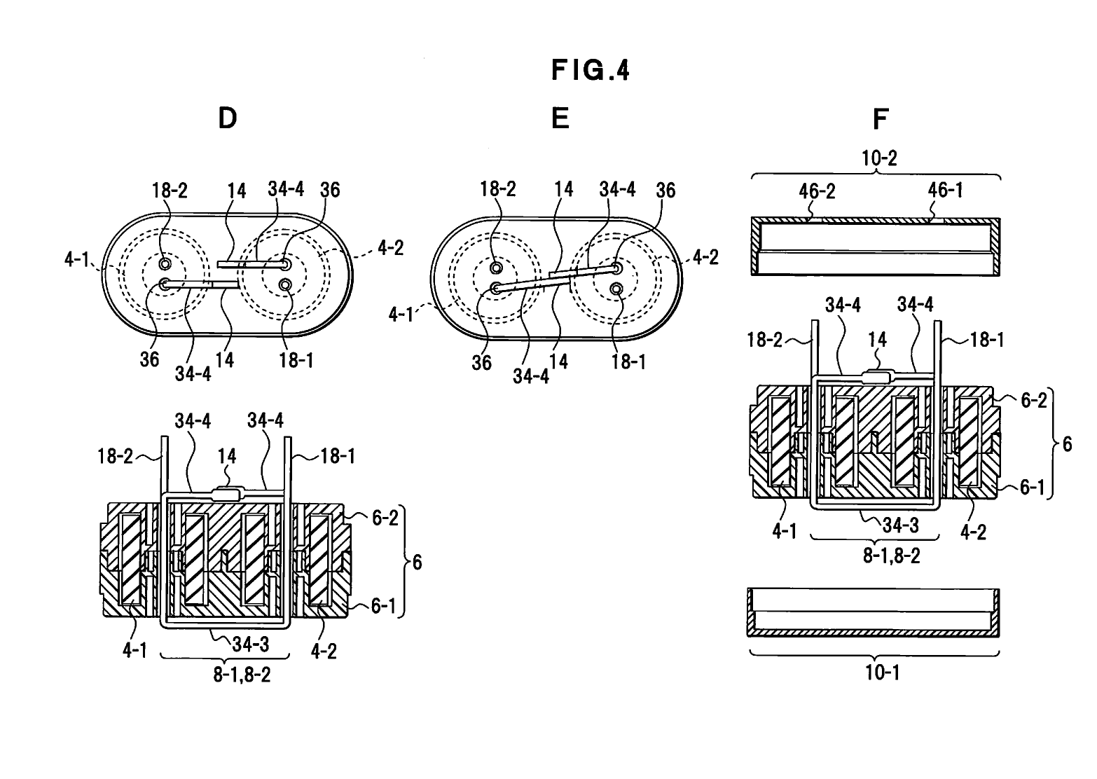

FIGS. 3 and 4 show manufacturing steps of the coil 2. The manufacturing steps are an example of a method for manufacturing the coil of the present invention.

The cores 4-1, 4-2 are formed by molding processing of an amorphous material, for example. The core cases 6-1, 6-2 are formed by molding of an insulating synthetic resin.

As shown in A, the cores 4-1, 4-2 are stored in the core storage parts 22 of the core case 6-1 and are covered by the core case 6-2 from above so that the core cases 6-1, 6-2 are coupled.

Subsequently, as shown in B, two columnar wire rods such as copper wire having the full length L {=L1+2×(L2+L3)} are used and each bent into, for example, a U-shape at the two bent parts 36 with the bridging part 34-3 of the length L1 disposed between the two bent parts 36 to form the coil conductor pieces 8-1, 8-2.

Subsequently, as shown in C, the coil conductor pieces 8-1, 8-2 penetrate through the conductor through-holes 30-1, 30-2 of the core cases 6-1, 6-2 combined with each other with the cores 4-1, 4-2 stored therein, so that the coil conductor pieces 8-1, 8-2 are mounted on the core cases 6-1, 6-2.

Subsequently, as shown in D, the end parts serving as the coupling parts 14 are shaped on the bridging part 34-4 side of the coil conductor pieces 8-1, 8-2 projected from the conductor through-holes 30-1, 30-2 of the core cases 6-1, 6-2.

The bridging parts 34-4 of the coil conductor pieces 8-1, 8-2 are bent at right angles in the opposing directions at the bent parts 36 to cause flat surfaces of the coupling parts 14 to face each other.

Subsequently, as shown in E, the coil conductor pieces 8-1, 8-2 are connected by, for example, ultrasonic welding, between the coupling parts 14 located in the opposing directions of the bridging parts 34-4. As a result, the coil conductor pieces 8-1, 8-2 are integrated to form the single circling part 16 so that the cores 4-1, 4-2, the core cases 6-1, 6-2, and the coil conductor pieces 8-1, 8-2 are processed into a single component.

Subsequently, as shown in F, the cover 10-1 is put on the core case 6-1 so that the bridging parts 34-3 exposed from the core case 6-1 are covered by the cover 10-1.

Similarly, the cover 10-2 is put on the core case 6-2 so that the bridging parts 34-4 and the coupling parts 14 exposed from the core case 6-2 are covered by the cover 10-2. In this case, the lead parts 18-1, 18-2 penetrate through the leading-out holes 46-1, 46-2 of the cover 10-2 and are led out from the leading-out holes 46-1, 46-2. As a result, the coil 2 shown in FIG. 1 is completed.

<Functions and Effects of Embodiment>

(1) About Cores 4-1, 4-2:

Since the cores 4-1, 4-2 are made of an amorphous material that is a high magnetic permeability material, a high inductance is acquired. As compared to the case of being made of other core materials, the cores 4-1, 4-2 can be reduced in size and volume when the same inductance is acquired. When a higher inductance is achieved by the cores 4-1, 4-2, the coil conductor pieces 8-1, 8-2 can be shortened in the conductor length and reduced in the circling number of the circling part 16, so that the occupied volume of the coil conductor pieces 8-1, 8-2 can be made smaller in the coil 2. As a result, the direct current resistance of the coil 2 can be reduced. Since the coil conductor pieces 8-1, 8-2 can be reduced in the circling number, the bore diameter of the through-holes 12 of the cores 4-1, 4-2 can be made smaller.

(2) About Coil Conductor Pieces 8-1, 8-2:

Since the coil conductor pieces 8-1, 8-2 are coupled to achieve a structure circling around the cores 4-1, 4-2, the need for a winding process is eliminated as compared to the case of winding a wire rod, and the coil structure of the coil conductor pieces 8-1, 8-2 can be achieved by the insertion through the cores 4-1, 4-2 and the coupling process of the coil conductor pieces 8-1, 8-2, so that the winding process of the wire rod can be eliminated.

As compared to the case of winding a wire rod, since the coil conductor pieces 8-1, 8-2 are disposed around the core 4-1 and the core 4-2 after the bent parts 36 are formed in advance, a length necessary for bending can be eliminated in the coil conductor pieces 8-1, 8-2. In the case of a wire rod, while the wire rod is partially disposed in the conductor through-hole 30-1, the other side of the wire rod must be bent and inserted into the conductor through-hole 30-1 and, therefore, the wire rod is bent with a bent part largely curved. By preliminarily bending into a U-shape as in this embodiment, the length of the bent part can be made shortest, so that a lower direct current resistance can be achieved. Because of the preliminarily bent structure, a more remarkable effect is produced when the coil conductor pieces 8-1, 8-2 are made thicker so as to reduce the direct current resistance. In the case of a wire rod, a wire rod made thicker increases the rigidity and becomes hard to bend and it is therefore assumed that the bent part is more largely curved; however, when the bent part is formed in advance as in the present invention, the coil conductor pieces can be bent in a shortest distance even when being made thicker. As described above, this configuration can satisfy both the suppression of the direct current resistance and the reduction in size.

Additionally, by making the coil conductor pieces 8-1, 8-2 shorter and reducing the direct current resistance, the heat generation can be suppressed.

Since the coil conductor pieces 8-1, 8-2 are used, the uniformity can be achieved in the coil shape made up of the coil conductor pieces 8-1, 8-2, so that the acquired inductance value can be made uniform.

(3) About Core Cases 6-1, 6-2:

The core cases 6-1, 6-2 are formed into small containers having minimal capacities covering the periphery of the appearance shape of parallel arrangement of the cores 4-1, 4-2. The core cases 6-1, 6-2 are detachably coupled, and the cores 4-1, 4-2 are positioned and held at predetermined positions. As a result, the cores 4-1, 4-2 are integrated with the core cases 6-1, 6-2, retained in shape and made robust. As a result, the uniformity of the appearance shape of the coil 2 is improved.

Since the core cases 6-1, 6-2 are made of the insulating synthetic resin, the insulation of the cores 4-1, 4-2 can be achieved, and the insulation can be achieved between each of the cores 4-1, 4-2 and each of the coil conductor pieces 8-1, 8-2.

Since the core cases 6-1, 6-2 are integrated by a fitting structure, the core cases 6-1, 6-2 have a high coupling strength and an increased vibration resistance, so that the appearance shape can be made uniform.

Since the coil conductor pieces 8-1, 8-2 are respectively separately disposed in the conductor through-holes 30-1, 30-2, the contact between the coil conductor pieces 8-1, 8-2 can be prevented. Therefore, even when the cores 4-1, 4-2 are reduced in size and the through-holes 12 are made smaller such that the coil conductor pieces 8-1, 8-2 are brought closer to each other, the contact can be prevented and a short circuit due to a reduction in size can be prevented.

(4) About Covers 10-1, 10-2:

The covers 10-1, 10-2 are integrated with the integrated core cases 6-1, 6-2 by the fitting structure and can cover the coil conductor pieces 8-1, 8-2 exposed from the core cases 6-1, 6-2 so as to maintain the insulation of the coil conductor pieces 8-1, 8-2 and improve the insulation performance.

Since the covers 10-1, 10-2 are combined with the core cases 6-1, 6-2, the coil 2 can be improved in the water resistance and the robustness, and the lead parts 18-1, 18-2 of the coil conductor pieces 8-1, 8-2 can be protected.

Since the covers 10-1, 10-2 are coupled to the core cases 6-1, 6-2 by the fitting structure, this enables the higher coupling strength therebetween, the smaller appearance shape of the coil 2, and the flattening of the side and bottom surfaces of the coil 2.

(5) About General Structure:

The coil 2 can have a higher inductance, a smaller size, a lighter weight, and a lower resistance, can be made uniform in product quality, and can be acquired as a product with good quality with reduced manufacturing costs. Since the coil 2 is made robust, the vibration resistance is improved so that a product with resistance properties suitable for a mobile object component such as a vehicle is acquired.

Since the coil conductor pieces 8-1, 8-2 mounted on the core cases 6-1, 6-2 are flatly connected through shaping of the coupling parts 14, the coil 2 can be reduced in size by disposing the coupling parts 14 of the coil conductor pieces 8-1, 8-2 on an outer surface part of the core case 6-2.

Since the coupling parts 14 are connected by ultrasonic welding, even when the coil 2 is used in a high temperature environment, connecting performance can be maintained in terms of the separation of the connecting portion and as compared to conventional connection by solder, so that the coil performance can be improved.

<Arrangement of Coil Conductor Pieces 8-1, 8-2 and Modification Example Thereof>

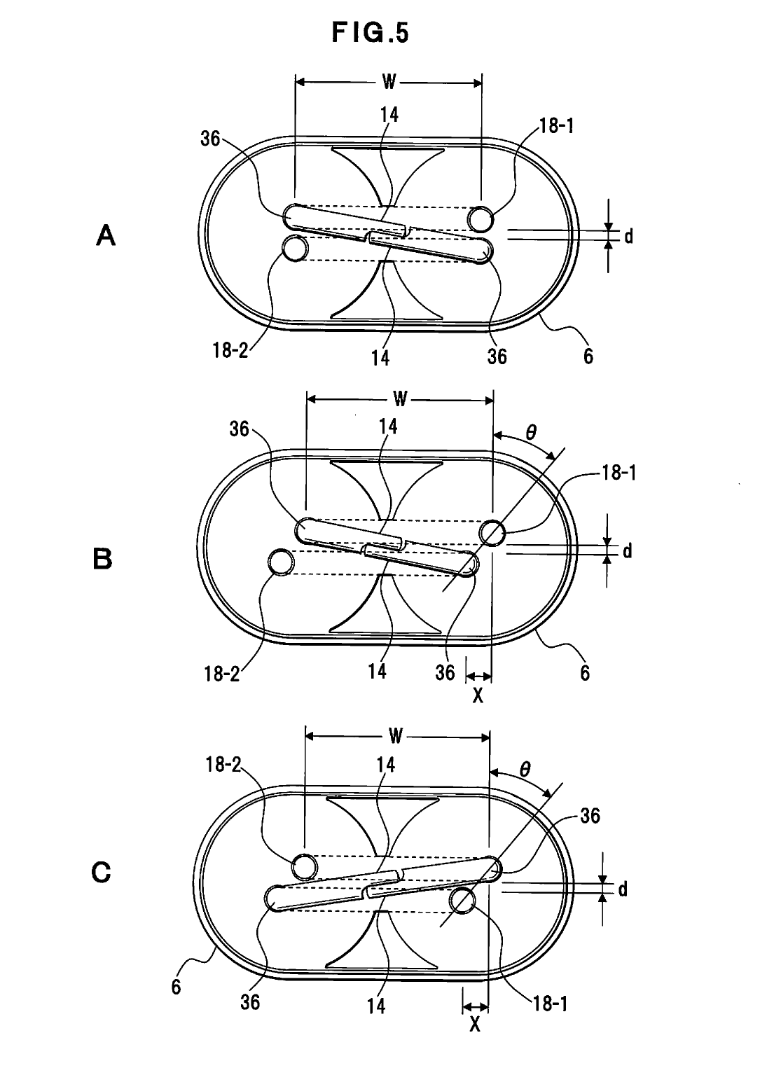

In the embodiment, as shown in A of FIG. 5, the coil conductor pieces 8-1, 8-2 are arranged on the core cases 6-1, 6-2 in a constant width W at a constant insulation interval d by a pair of the conductor through-holes 30-1, 30-2 positioned and shaped at positions of the same width W in the diameter direction of the through-hole 12 of the cores 4-1, 4-2. As a result, the penetrating parts 34-1, 34-2 of the coil conductor pieces 8-1, 8-2 are held at constant intervals in hollow parts of the through-holes 12 of the cores 4-1, 4-2, so that the coil conductor pieces 8-1, 8-2 can be prevented from short-circuiting due to contact.

On the other hand, as shown in B of FIG. 5, a displacement X may be set in the X-axis direction to displace the arrangement positions of the coil conductor pieces 8-1, 8-2 by an inclination angle θ.

In this case, for example, while the width W and the insulation interval d are maintained at the same width and interval, the bridging parts 34-4 may be connected on the short distance sides of the coil conductor pieces 8-1, 8-2 to form the coupling parts 14.

As shown in C of FIG. 5, the displacement X may be set in the X-axis direction to displace the arrangement positions of the coil conductor pieces 8-1, 8-2 by the inclination angle θ with the width W and the insulation interval d, for example, maintained at the same width and interval, or set to different width and interval, and the bridging parts 34-4 may be connected on the long distance sides of the coil conductor pieces 8-1, 8-2 to form the coupling parts 14.

<Modification Examples of Number of Turns of Circling Part 16, Shape of Coil Conductor Pieces 8-1, 8-2, Auxiliary Coil Conductor Piece 8-3, Coupling Part 14, and Lead-Out Direction of Lead Parts 18-1, 18-2>

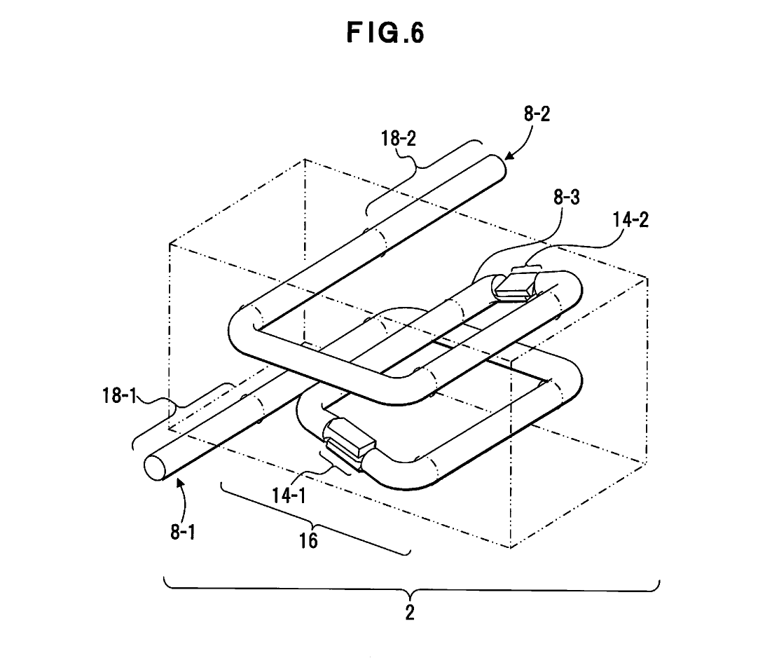

The circling number N of the circling part 16 may be two or more as shown in FIG. 6, for example.

The shape of the coil conductor pieces 8-1, 8-2 may be shapes other than the U-shape, such as L-shape, as well as the U-shape shown in FIG. 6, for example.

The coil conductor pieces 8-1, 8-2 may be provided with a C-shaped auxiliary coil conductor piece 8-3 as shown in FIG. 6, for example. The auxiliary coil conductor piece 8-3 may include coupling parts 14-1, 14-2 on both ends to couple the coil conductor pieces 8-1, 8-2.

With regard to the lead-out directions of the lead parts 18-1, 18-2, for example, as shown in FIG. 6, leading-out parts may be set in end surface parts on the opposite sides of the coil 2 to lead out the lead parts 18-1, 18-2 from different surface parts.

<Modification Examples of Wall Part Interposed Between Coil Conductor Pieces 8-1, 8-2>

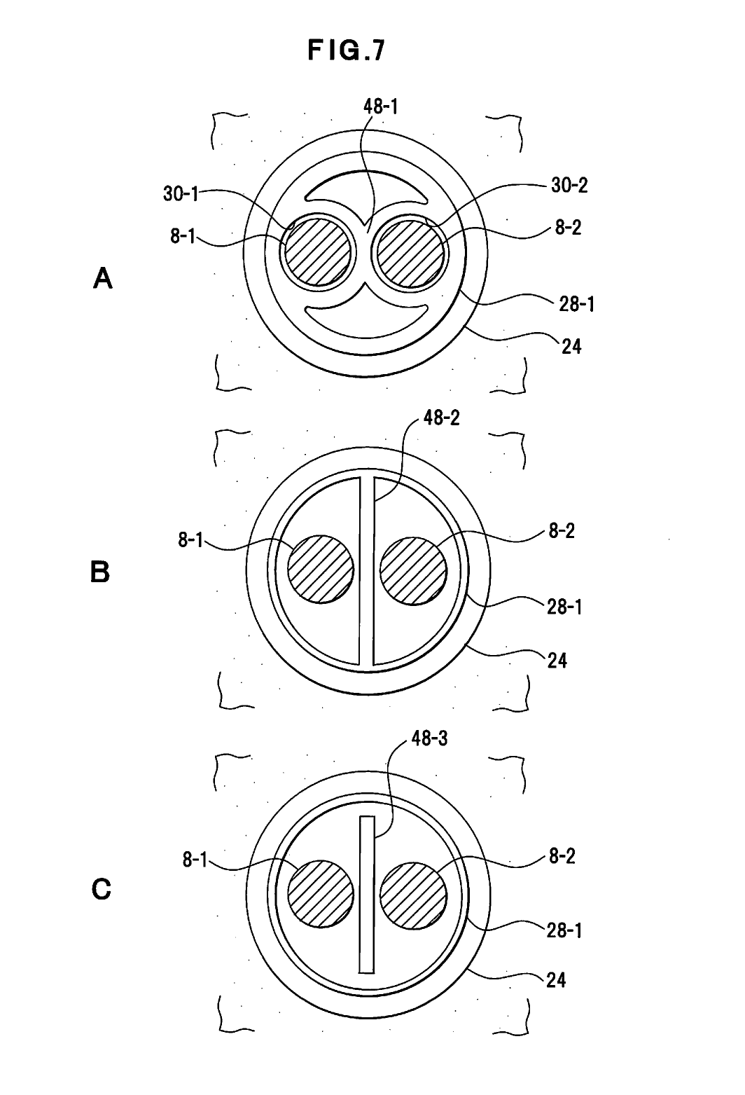

In the embodiment, the wall part of the conductor through-holes 30-1, 30-2, i.e., an example of a separation wall interposed between the coil conductor pieces 8-1, 8-2, has the shape including a partition wall 48-1 covering the coil conductor pieces 8-1, 8-2 and partitioning the coil conductor pieces 8-1, 8-2 as in the case of the conductor through-hole 30-1, 30-2 as shown in A of FIG. 7; however, this is not a limitation and, for example, as shown in B or C of FIG. 7, a partition wall 48-2, 48-3 partitioning the coil conductor pieces 8-1, 8-2 may be formed or disposed in the small diameter fitting part 28-1.

<Modification Example of Core Cases 6-1, 6-2>

Although the two core storage parts 22 are formed in each of the core cases 6-1, 6-2 in the embodiment, this is not a limitation and, the cores 4-1, 4-2 maybe stored in respective core cases such that the two core cases are arranged in parallel. In this case, the core cases may be fixed by a fixing member such as a tape material or an adhesive material.

<Experimental Result>

Example A and Comparison Example B shown in Table 1 were used for an experiment. Example A is the coil 2. An amorphous material is used for the core material of the coil 2. The cores 4-1, 4-2 of the coil 2 have the diameter Φ of 15 [mm] and the length of 15 [mm]. The circling number of the coil 2 is described above. The coil conductor pieces 8-1, 8-2 have the wire diameter Φ of 2.0 [mm], the direct current resistance R of 0.8 [mΩ], and the volume of the circling part 16 (coil volume) of 14.6 [mm³].

On the other hand, an iron dust is used for the core material of Comparison Example B. The core of Comparison Example B has the diameter Φ of 24 [mm] and the length of 9 [mm]. Two wire rods having the coil wire diameter Φ of 1.8 [mm] are uses for the coil conductors. A coil formed by 11 turns of the wire rods, i.e., by winding each of the two wire rods 11 times has the direct current resistance R of 1.1 [mΩ] and the coil volume of 15.3 [mm³].

TABLE 1

| | | | | | A/B |
|---|---|---|---|---|---|
| | | | COMPARISON | | RATIO |
| | EXAMPLE A | | EXAMPLE B | | (%) |
| CORE MATERIAL | AMORPHOUS | | IRON DUST | | — |
| CORE SIZE | φ 15 × 15L × 2 PIECES | | φ 24 × 9L | | — |
| NUMBER OF | 2 | Turns | 11 | Turns | — |
| TURNS | | | | | |
| COIL DIAMETER | φ 2.0 | | φ 1.8 | | — |
| NUMBER OF COIL | ONE COIL | | TWO COILS | | — |
| DIRECT CURRENT | 0.8 | mΩ | 1.1 | mΩ | 72.7% |
| COIL VOLUME | 14.6 | mm³ | 15.3 | mm³ | 95.4% |

In comparison between Example A and Comparison Example B, since the A/B ratio [%] of the direct current resistance is 72.7 [%] and the A/B ratio [%] of the coil volume is 95.4 [%], Example A has a significantly reduced direct current resistance with a smaller size and a smaller volume.

Since the amorphous material is used for the core material in Example A and this amorphous material is a material with a high magnetic permeability, the inductance of the coil. can be made higher. As a result, the number of turns of the copper wire can be made smaller and the direct current resistance can be reduced.

Since the coil conductor structure integrating by connection circles substantially twice in the circling part, a smaller size and a reduction in the direct current resistance can be achieved while thick copper wires are usable.

In the structure of winding one lead wire twice as in Comparison Example B instead of achieving the circling structure by the coil conductor pieces 8-1, 8-2 as in Example described above, the coil wire diameter Φ must be 1.0 [mm] or less so as to achieve a size equivalent to the welded structure. When a reduction in dimension of the wire diameter is included, the coil structure achieved by winding a copper wire having the wire diameter Φ of 1.0 [mm] twice has a high direct current resistance of about 3.2 [mΩ] as design value, and cannot suppress heat generation.

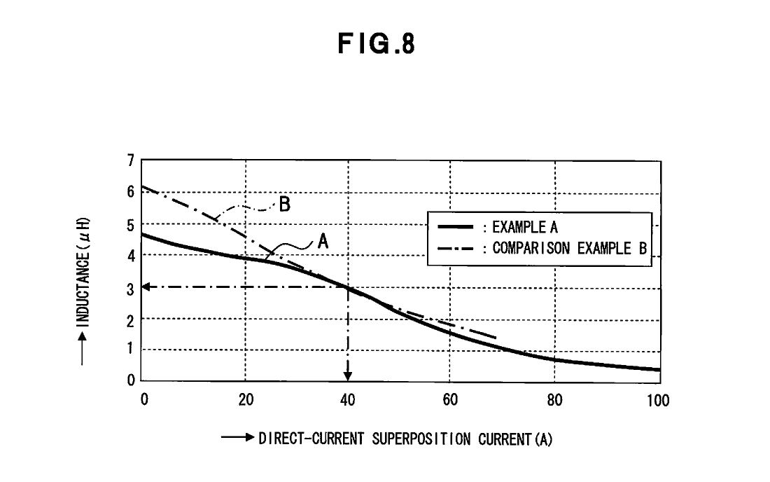

FIG. 8 shows direct-current superposition inductance characteristics of Example A and Comparison Example B. If Example A and Comparison Example B are designed to acquire 3 [μH] at the direct-current superposition current of 40 [μH], Example A acquires the inductance in the width of 1.5 to 3.9 [μH] at a direct-current superposition current of 20 to 60 [A].

In Example A, when a higher inductance is acquired, a direct current value becomes lower. For example, the direct-current superposition current for acquiring the inductance of 4 [μH] is approximately 20 [A] in Example A, while the current is 25 to 30 [A] in Comparison Example B, and Comparison Example B is associated with a larger direct-current superposition current. It can be presumed from FIG. 8 that this difference in direct-current superposition current becomes lager when the inductance is higher.

The coil conductor pieces 8-1, 8-2 of the embodiments are not limited to those having a circle-shaped cross section and the cross section may be polygonal or elliptical. The cores 4-1, 4-2 may have a circle shape and may have a square shape or an elliptical shape as needed.

The coil 2 may vertically be mounted such that the leading-out holes 46-1, 46-2 of the cover 10-2 face a substrate. The coil may horizontally be placed such that the side surfaces of the cores 4-1, 4-2 face the substrate, and may be mounted on the substrate with the lead parts 18-1, 18-2 folded. Such horizontal placement can make the height dimension from a substrate surface smaller as compared to vertical placement. Additionally, by making the height dimension smaller, the center of gravity of the coil 2 can be lowered to improve the vibration resistance. Moreover, by disposing auxiliary terminals to achieve a form capable of connection with the substrate, the horizontal placement of the coil 2 can improve the connectability of the core cases 6-1, 6-2 or the covers 10-1, 10-2 to the substrate.

Aspects of coils or methods manufacturing coils extracted from the embodiments described above are as follows.

An aspect of a coil may include a plurality of coil conductor pieces made of a high magnetic permeability material; first and second cores including through-holes in parallel, the through-holes allowing penetration of the coil conductor pieces; and a case in which the first core and the second core are stored, wherein a coil conductor is made up of the plurality of coil conductor pieces, the coil conductor circling between the first and second cores, at least one end part of one of the coil conductor pieces being coupled to an end part of the other coil conductor piece on the outside of the case, the one of the coil conductor pieces penetrating through the through-holes of the first core and the second core.

In the coil, the case may include a wall part between portions of the coil conductor allowed to penetrate through the through-holes of the first core and the second core.

In the coil, the case may include recesses in which the first core and the second core are inserted, and the first core and the second core may be supported by the recesses.

In the coil, the core maybe a magnetic core made up of a wound magnetic alloy ribbon.

In the coil, the coil conductor pieces may include shaft parts each penetrating the through-hole of the first core or the second core and bent parts bent in a direction of a place between the cores.

An aspect of a method for manufacturing a coil may include forming coil conductor pieces and forming first and second cores including through-holes allowing penetration of the coil conductor pieces; storing the first core and the second core in a case to arrange the through-holes in parallel; and coupling at least one end part of one of the coil conductor pieces to an end part of the other coil conductor piece penetrating through the through-holes of the first core and the second core to form a coil conductor made up of the plurality of coil conductor pieces, the coil conductor circling between the first and second cores.

An aspect of the method for manufacturing a coil may further include forming a shaft part allowing the coil conductor piece to penetrate the through-hole of the first core or the second core and bent parts bent in a direction of a place between the cores, and inserting the shaft part into the through-hole.

According to aspects of the coils or the methods for manufacturing the same of the embodiments, the following effects can be provided.

(1) Since the coil conductor pieces shaped in advance are used, a shortened conductor circling length and a lower resistance can be achieved. Since the cores are formed of a high magnetic permeability material, a higher inductance can be achieved without increasing the circling number.

(2) Since the higher inductance can be achieved, when a coil with the same inductance is designed, the coil can be reduced in size as compared to conventional coils.

(3) Since the coil conductor is formed by mounting the coil conductor pieces shaped in advance on the cores, a trouble of winding a wire rod around the cores can be eliminated.

(4) Since the shaped coil conductor pieces are used, a layer short can be restrained from occurring due to pulling a wire rod and winding the wire rod around the cores.

(5) Since the cores are stored in the case, the insulation between the coil conductor pieces and the cores can be easily ensured.

(6) The resistance of the coil can be made lower so as to prevent the heat generation of the coil.

As described above, most preferable embodiments etc. of the coil and the method for manufacturing the same have been described. The present invention is not limited to the description. Those skilled in the art can make various modifications and alterations based on the spirit of the invention described in claims or disclosed in modes for carrying out the invention. These modifications and alterations obviously fall within the scope of the present invention.

According to the present invention, by attaching a plurality of coil conductor pieces to a core formed by using a high magnetic permeability material such as an amorphous material, and by coupling the coil conductor pieces to form a coil conductor, a small-sized high-inductance coil and a method for manufacturing the same can be provided and used in an apparatus or a circuit to which an inductance should be applied, which is useful.

According to the present invention, since an insulating structure and a circling structure of coil conductor pieces are included, a unit having a composite LC circuit of a coil and a capacitor can be easily achieved by attaching an electronic component such as a capacitor to a lead part and leading out a lead wire and, additionally, reductions in the number of components and the man-hour for attaching can be achieved, which is effective.

1. A coil comprising:
a plurality of coil conductor pieces made of a high magnetic permeability material;
first and second cores including through-holes in parallel, the through-holes allowing penetration of the coil conductor pieces; and
a case in which the first core and the second core are stored, wherein
a coil conductor is made up of the plurality of coil conductor pieces, the coil conductor circling between the first and second cores, at least one end part of one of the coil conductor pieces being coupled to an end part of the other coil conductor piece on the outside of the case, the one of the coil conductor pieces penetrating through the through-holes of the first core and the second core.

2. The coil according to claim 1, wherein the case includes a wall part between portions of the coil conductor allowed to penetrate through the through-holes of the first core and the second core.

3. The coil according to claim 1, wherein the case includes recesses in which the first core and the second core are inserted, and wherein the first core and the second core are supported by the recesses.

4. The coil according to claim 1, wherein the core is a magnetic core made up of a wound magnetic alloy ribbon.

5. The coil according to claim 1, wherein the coil conductor pieces include shaft parts each penetrating the through-hole of the first core or the second core and bent parts bent in a direction of a place between the cores.

6. A method for manufacturing a coil, the method comprising:
forming coil conductor pieces and forming first and second cores including through-holes allowing penetration of the coil conductor pieces;
storing the first core and the second core in a case to arrange the through-holes in parallel; and
coupling at least one end part of one of the coil conductor pieces to an end part of the other coil conductor piece penetrating through the through-holes of the first core and the second core to form a coil conductor made up of the plurality of coil conductor pieces, the coil conductor circling between the first and second cores.

7. The method for manufacturing a coil according to claim 6, further comprising forming a shaft part allowing the coil conductor piece to penetrate the through-hole of the first core or the second core and bent parts bent in a direction of a place between the cores, and inserting the shaft part into the through-hole.
